(19) United States
(12) Patent Application Publication
(10) Pub. No.: US 2007/0127517 A1
(43) Pub. Date: Jun. 7, 2007

(54) Network infrastructure capable of enhancing interactivity

(75) Inventors: Wayne Sung, Taipei City (TW); Lip Eang Zhao, Taipei City (TW)

Correspondence Address: BIRCH STEWART KOLASCH & BIRCH, PO BOX 747, FALLS CHURCH, VA, 22040-0747, US

(73) Assignee: Interactive Multimedia Exchange Inc.

(21) Appl. No.: 11/598,678

(22) Filed: Nov. 14, 2006

(30) Foreign Application Priority Data
Dec. 2, 2005 (TW) 094142741

(51) Int. Cl. H04L 12/413

(52) U.S. Cl. 370/448

(57) ABSTRACT

A network architecture for enhancing interactivity for use with an electric apparatus comprises a remote device, a wide area network and a near-end device. The remote device automatically logs onto a relay server as soon as power is turned on. A display unit of the near-end device displays a login mark to indicate the remote device is online. The remote device outputs notification data, upon detection of a trigger event to inform the near-end device that the trigger event has occurred. The remote device performs a corresponding response action, if the near-end device outputs a command signal.

### BACKGROUND OF THE INVENTION

(a) Field of the Invention

The present invention relates to a network architecture, particularly to a network architecture capable of enhancing interactivity between a remote device and a near-end device via software programs.

(b) Description of the Prior Art

Considering the wide applicability of the Internet, Internet efficiency becomes a major issue. To ordinary Internet users, Internet technology is extremely difficult and so is network maintenance. Numerous technical terms such as wide area network (WAN), local area network (LAN), Internet Protocol Address, Asymmetric Digital Subscriber Line (ADSL) modems, cable modems and so on are difficult for general Internet users to understand.

For conventional technology, when users log into the network, numerous settings are required, and moreover, users need to memorize numerous user accounts, passwords and E-mail addresses, thus causing them a lot of troubles. Especially for some users who have insufficient knowledge of computer, they dare not contact these network products. In this way, network products are not easily accepted by the users, thereby inhibiting Internet applicability. Moreover, users often lose the opportunities of using network products.

On the other hand, due to the insufficient interactivity between the near-end and the remote-end inherent in the conventional technology, in case changes happen to the near-end status, remote users often fail to recognize this. For example, the remote-end fails to actively detect the near-end status. In other words, when near-end Internet protocol address changes, the remote-end fails to actively detect the near-end Internal protocol address, which is deemed as a drawback of conventional network products. Moreover, due to insufficient interactivity between the near-end and the remote-end inherent in the conventional technology, the applicable scope and performance of network products are greatly restricted, thus seriously inhibiting the progress of the industry.

### SUMMARY OF THE INVENTION

The primary object of the present invention is to provide a network infrastructure capable of enhancing interactivity, such that users can conveniently use network products without the need to memorize a lot of information such as users accounts, passwords, and E-mail addresses. Moreover, the present invention enhances interactivity and real-timeness of both the near-end and remote-end.

To achieve the above objects, the present invention provides a network infrastructure capable of enhancing interactivity for use with an electronic apparatus. The network infrastructure includes a remote device, a wide area network and a near-end device, wherein the remote device further includes at least a first micro-processing unit and a first memory unit. The remote device is coupled to the wide area network via cable or wireless communication. The first memory unit is coupled to the first micro-processing unit, which is employed to perform an automatic login procedure. Once power is turned on, the first micro-processing unit performs the automatic login procedure to automatically connect to the wide area network and log into a service server.

Moreover, the near-end device includes at least a second micro-processing unit, a second memory unit and a display unit. The near-end device is coupled to the wide area network via cable or wireless communication. Both the second memory unit and the display unit are coupled to the second micro-processing unit. After the near-end device has logged into a service server via software, the display unit displays an online mark to indicate that the remote device is online. Upon detection of a trigger event, the remote device outputs at least a notification data to notify the remote device that the trigger event has occurred. If the near-end device outputs at least a command signal, the remote device performs a response action.

According to a preferred embodiment of the present invention, the remote device further includes a first data unit, which is coupled to the first micro-processing unit and the wide area network to facilitate data transmission between the remote device and the wide area network.

According to another preferred embodiment of the present invention, the first data unit is an Asymmetric Digital Subscriber Line (ADSL) modem.

According to another preferred embodiment of the present invention, the first data unit is a cable modem.

According to another preferred embodiment of the present invention, the first data unit is a wireless modem.

According to another preferred embodiment of the present invention, the remote device further includes a second data unit, which is coupled to the second micro-processing unit and the wide area network to facilitate data transmission between the near-end device and the wide area network.

According to another preferred embodiment of the present invention, the second data unit is an Asymmetric Digital Subscriber Line (ADSL) modem.

According to another preferred embodiment of the present invention, the second data unit is a cable modem.

According to another preferred embodiment of the present invention, the second data unit is a wireless modem.

According to another preferred embodiment of the present invention, the automatic login procedure includes the step of the first micro-processing unit's initialization of the remote device and the step of logging in the service server via at least one account information of the first memory unit.

According to another preferred embodiment of the present invention, a plurality of account information of the first memory unit is employed to log in the service server.

According to another preferred embodiment of the present invention, the account information is an E-mail address.

According to another preferred embodiment of the present invention, the remote device is a network camera.

According to another preferred embodiment of the present invention, the near-end device is a mobile phone, personal computer or PDA.

According to another preferred embodiment of the present invention, the response data is an Internal protocol address.

According to another preferred embodiment of the present invention, the instant messaging software can be Yahoo Inc.'s Yahoo Messenger, Google Inc.'s Google Chat, Microsoft Corp.'s MSN Messenger or Skype Limited's Skype.

To enable a further understanding of the objectives and the technological methods of the invention herein, the brief description of the drawings below is followed by the detailed description of the preferred embodiments.

### BRIEF DESCRIPTION OF THE DRAWINGS

FIG. 1 shows a structural view of a network infrastructure capable of enhancing interactivity made according to a preferred embodiment of the present invention.

FIG. 2 shows a schematic view of the initialization of the structure made according to a preferred embodiment of the present invention.

FIG. 3 shows a schematic view of a trigger procedure made according to a preferred embodiment of the present invention.

FIG. 4 shows a schematic view of a request procedure made according to a preferred embodiment of the present invention.

FIG. 5 shows a structural view of a network infrastructure capable of enhancing interactivity made according to another preferred embodiment of the present invention.

FIG. 6 shows a schematic view of adding a contact person to a remote device made according to a preferred embodiment of the present invention.

FIG. 7 shows a schematic view of a contact list made according to a preferred embodiment of the present invention.

FIG. 8 shows a schematic view of an Instant Messenger window made according to a preferred embodiment of the present invention.

### DETAILED DESCRIPTION OF THE PREFERRED EMBODIMENTS

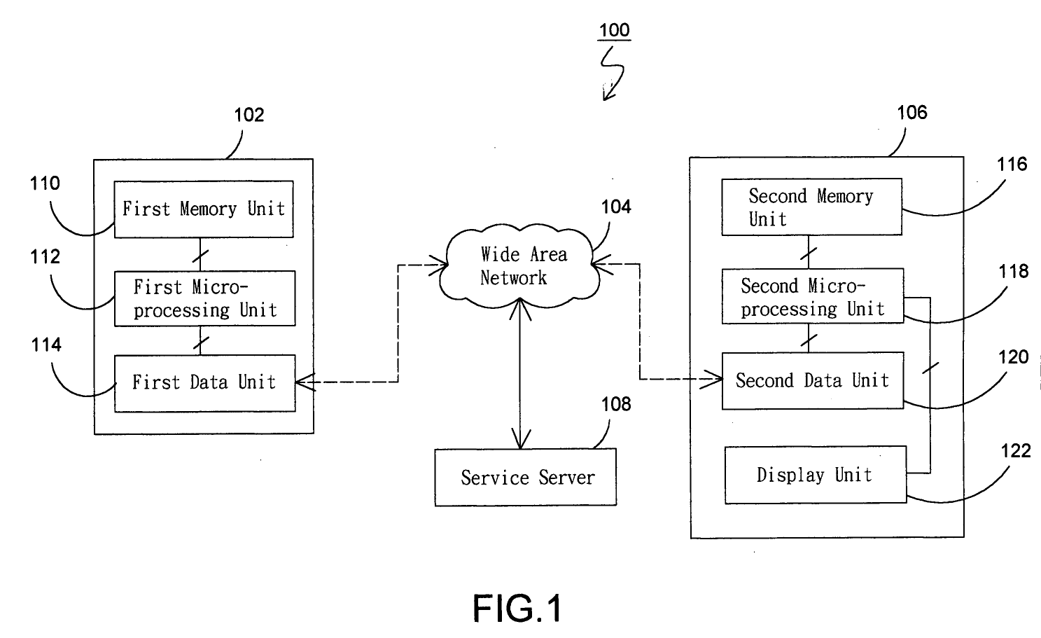

Referring to FIG. 1, the network infrastructure 1 capable of enhancing interactivity includes a remote device 102, a wide area network 104, a near-end device 106 and a service server 108, wherein the remote device 102 further includes a first memory unit 110, a first micro-processing unit 112 and a first data unit 114. The near-end device 106 further includes a second memory unit 116, a second micro-processing unit 118, a second data unit 120 and a display unit 122. The remote device 102 is coupled to the wide area network 104 via the first data unit 114 by means of cable or wireless communication. In a similar manner, the near-end device 106 is coupled to the wide area network 104 via the second data unit 120 by means of cable or wireless communication. Moreover, the first micro-processing unit 112 is electrically coupled to the first memory unit 110 and the first data unit 114. In a similar manner, the second micro-processing 118 is coupled to the second memory unit 116, the second data unit 120 and the display unit 122. Furthermore, the service server 108 is coupled to the wide area network 104.

According to a preferred embodiment of the present invention, the first data unit 114 and the second data unit 120 can be ADSL, cable or wireless modems. Data transmission occurs between the remote device 102 and the wide area network 104 via the first data unit 114 and also between the near-end device 106 and the wide area network 104 via the second data unit 120. The remote device 102 can be a network camera whereas the near-end device can be a PC, mobile phone or PDA. The first micro-processing unit 112 performs an automatic login procedure via account data (for example, E-mail addresses) and the first memory unit 110 stores the account data for logging in the service server 108. As soon as power is turned on, the first micro-processing unit 112 performs an automatic login procedure via application programs in order to be automatically connected to the wide area network 104. The remote device 102 then automatically logs into the service server 108. The application program includes operating systems. Considering that data retrieval and network login are prior arts, they are not described herein in details. After the near-end device 106 has logged into the service server 108 via software, the display unit 122 displays an online mark (not described in the drawing) to indicate the remote device 102 is online.

When the network infrastructure 100 performs a trigger procedure and if the remote device 102 detects a trigger event, the remote device 102 outputs at least a notification data to notify the near-end device that the trigger event has occurred. When the network infrastructure 100 performs a request procedure, and if the near-end device 106 outputs at least a command signal, the remote device 102 performs a response action. According to the preferred embodiment of the present invention, the software can be an instant messenger such as Yahoo Messenger, Google Chat, MSN Messenger and Skype. Considering the high market share of the above instant messengers, the network infrastructure 100 together with the instant messaging software can be applied for real-time operating interfaces, such that users need not repeat learning new operating interfaces. In addition, the automatic login procedure includes the step of the first micro-processing unit 112's initialization of the remote device for system settings, data retrieval, starting operating systems, loading application programs and the step of logging into the service server 108 via the account information of the first memory unit 110. The response action is a step of returning an Internet protocol address of the remote device 102 to the near-end device 106 or a step of returning the response data to the near-end device 106 by the remote device 102. The response data can be in the form of video or audio or enables video or audio connection of the remote device 102 and the service server 108. In addition, the notification data can be in the form of texts, video or audio.

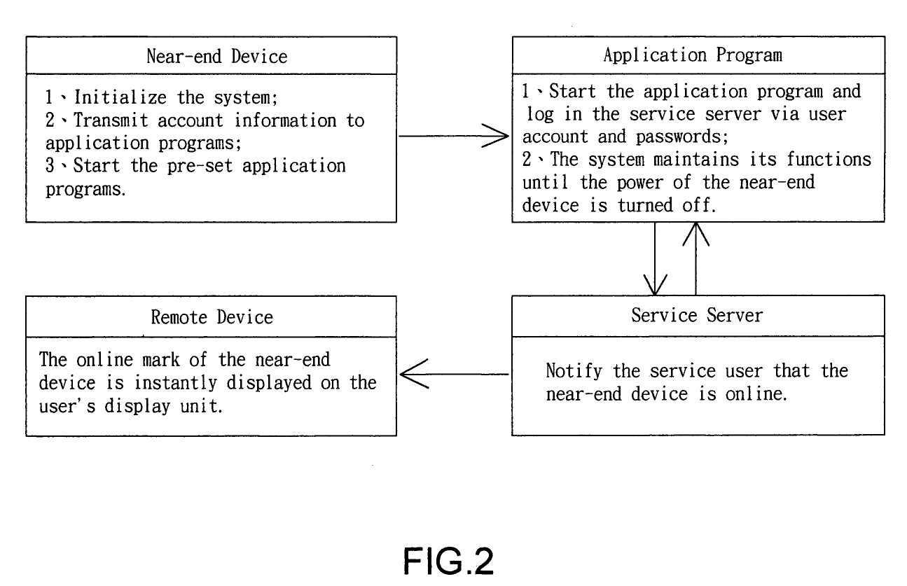

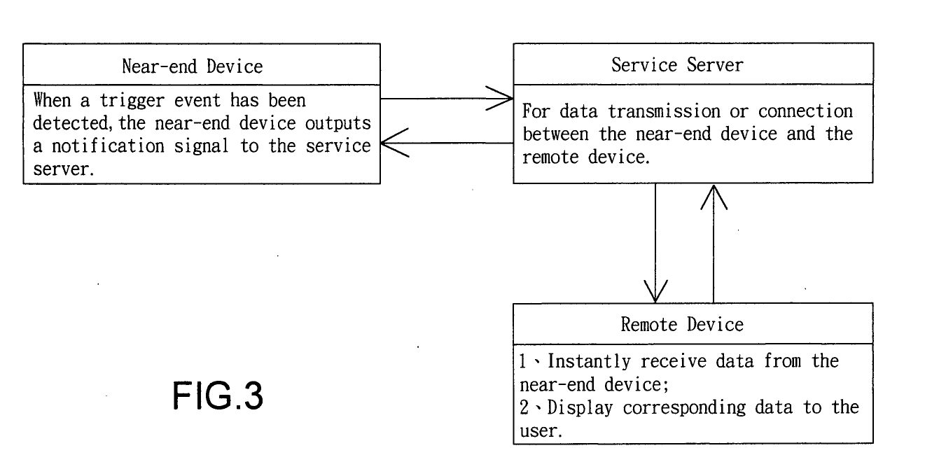

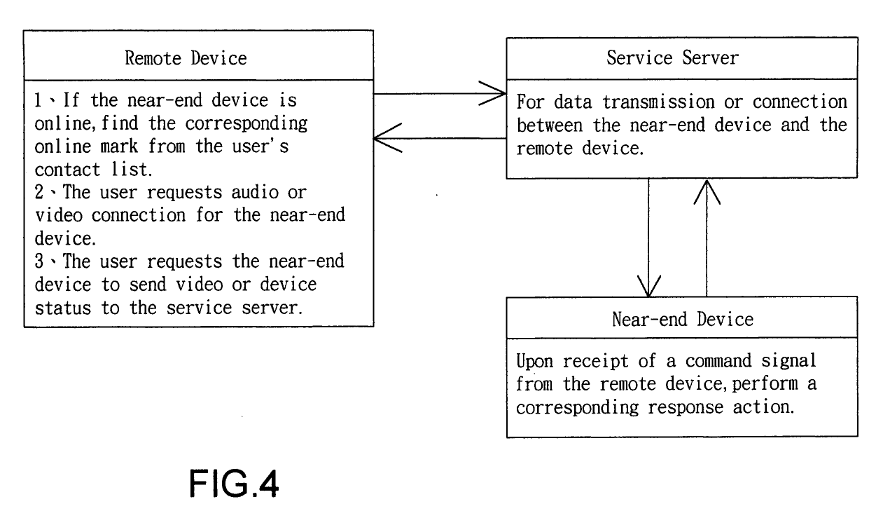

Referring to FIG. 2, during initialization, the remote device 102 logs into the service server 108 via application programs. An online mark will instantly appear on the display unit of the near-end device 106. Referring to FIG. 3, when the remote device 102 detects the trigger event, the near-end device 106 can instantly receive notification data. Referring to FIG. 4, the near-end device 106 can request the remote device 102 to be online, send information, indicate status, etc. The remote device 102 will perform corresponding response actions.

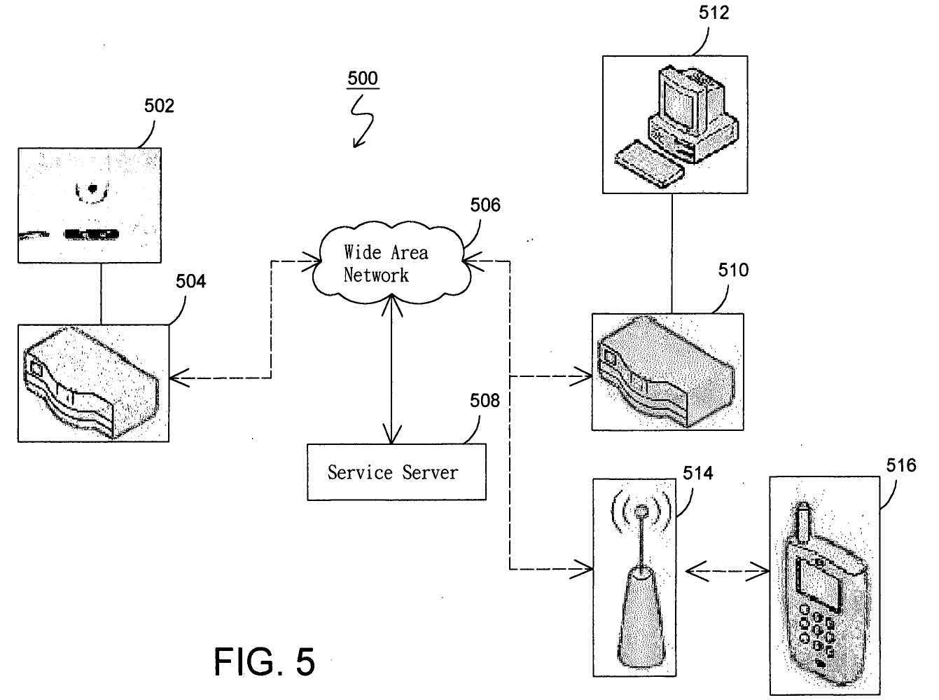

Referring to FIG. 5, the network infrastructure 500 capable of enhancing interactivity includes a network camera 502, a modem 504, a wide area network 506, a service server 508, a modem 510, a personal computer 512, an access point 514 and a mobile phone 516.

The network camera 502 is coupled to the wide area network 506 via the modem 504 whereas the personal computer 512 is coupled to the wide area network 506 via the modem 510. The mobile phone 516 is coupled to the wide area network via the access point 514.

For example, before leaving home, an user can turn on the power of the network camera 502, which will be automatically connected to the wide area network 506 and automatically log in the service server 508. The network camera 502 comprising an embedded micro-processing system executes application programs for the above actions. The service server 508 is a relay server, for example, the service server of MSN Messenger.

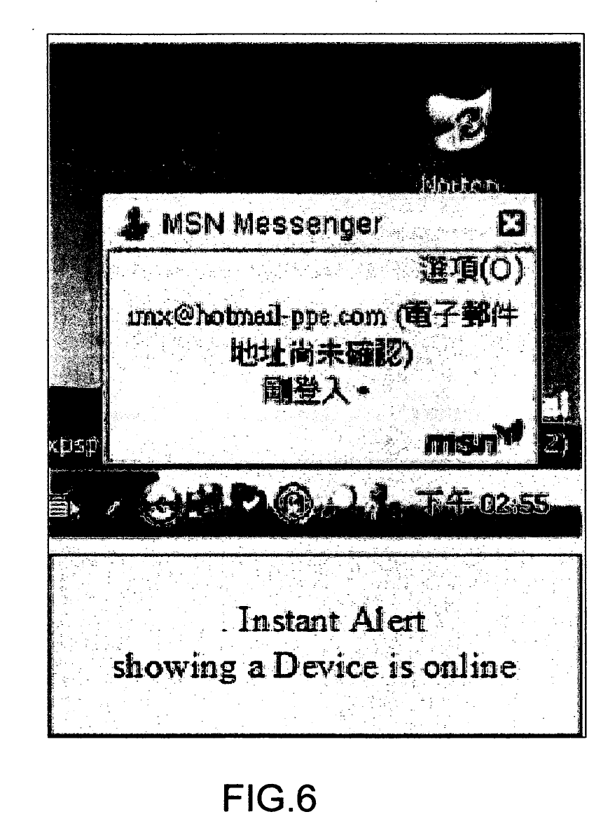

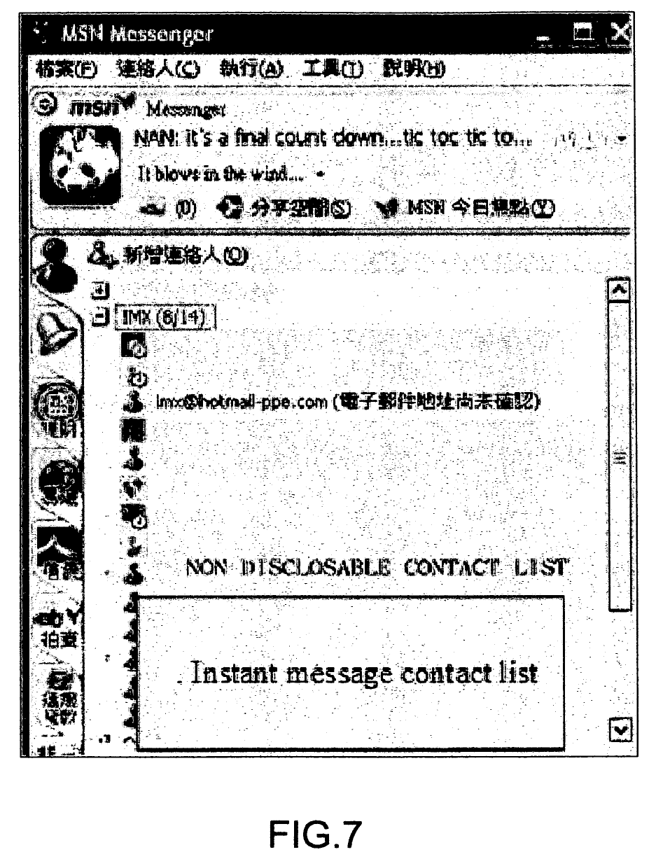

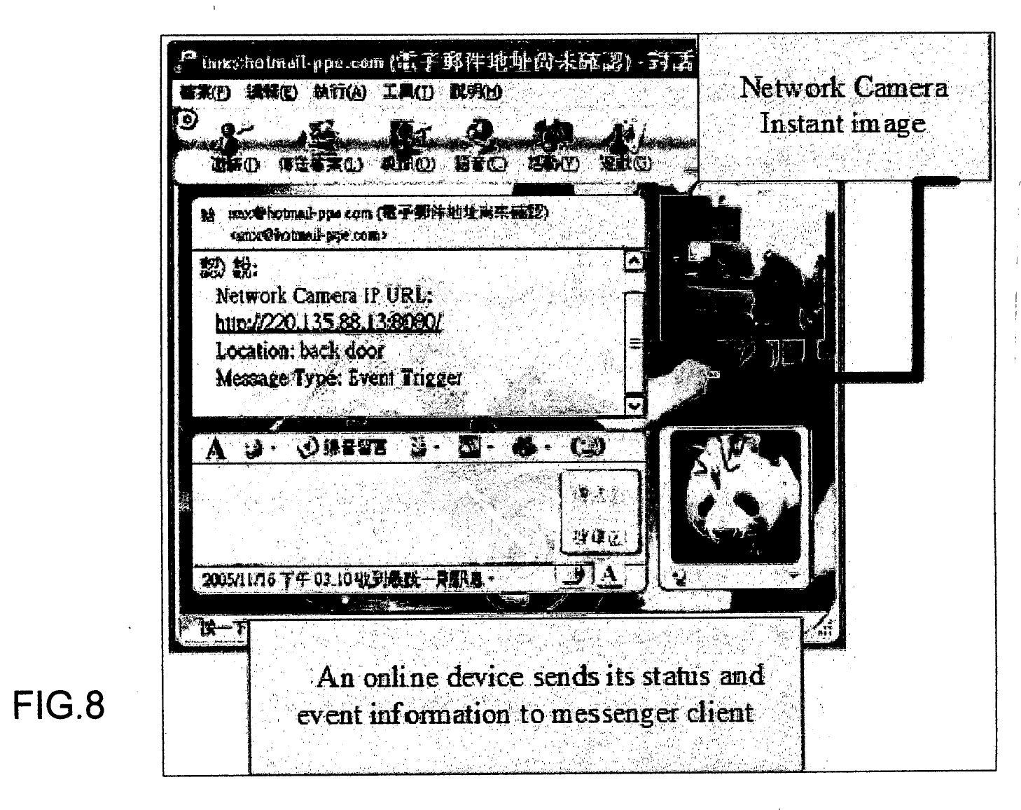

After the user reaches the office, he/she can connect to the wide area network 506 via the personal computer 512 and add an E-mail address corresponding to the network camera 502 via MSN Messenger, such that he/she can see the online mark of the network camera 502 from the contact list. In other words, under the operating interface of MSN Messenger, the network camera 502 can be considered a contact person, such that the user can open the video functions in the video window and see the screen returned from the network camera 502 (See FIG. 6, FIG. 7 and FIG. 8).

What is worth mentioning is that in FIG. 8, the instant messaging window will display the IP address (HTTP://220.135.88.13:8080) of the network camera 502. Among ordinary dial-up networks, in case changes are made to the dynamic IP address, the network infrastructure 500 will instantly notify the user that the IP has been changed. Moreover, the network infrastructure 500 enables the user to directly input commands via the instant messaging window, so as to remotely operate the network camera 502 or read the status of the network camera 502.

In summary, the present invention provides a network infrastructure capable of enhancing interactivity, such that Internet acceptability and convenience can be enhanced. Moreover, the present invention, in cooperation with highly popular instant messengers, provides updated services, such that the present invention becomes more appealing to users. Furthermore, the present invention provides transmission functions in the form of texts, audio or video, thereby enhancing the interaction with electronic apparatuses and industrial usability.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A network infrastructure capable of enhancing interactivity for use with an electronic apparatus, comprising:
a remote device, coupled to a wide area network via cable or wireless communication, further comprising:
a first multi-processing unit, for performing an automatic login procedure;
a first memory unit, coupled to said micro-processing unit; and
performing said automatic login procedure, after power is turned on, so as to be automatically connected to said wide area network and log in a service server; and
a near-end device, coupled to said wide area network via cable or wireless communication, further comprising:
a second micro-processing unit;
a second memory unit, coupled to said second micro-processing unit; and
a display unit, coupled to said second micro-processing unit; wherein
when said near-end device logs in said service server via software, an online mark is indicated on said display unit to indicate said remote device is online; and
when performing a trigger procedure and if said remote device detects a trigger event, said remote device outputs at least a notification data to notify said near-end device that said trigger event has occurred; when performing a request procedure and if said near-end device outputs at least a command signal, said remote device performs a response action.

2. The network infrastructure capable of enhancing interactivity as claimed in claim 1, wherein said remote device further comprises a first data unit, which is coupled to said first micro-processing unit and said wide area network for data transmission between said remote device and said wide area network.

3. The network infrastructure capable of enhancing interactivity as claimed in claim 2, wherein said first data unit is an ADSL modem.

4. The network infrastructure capable of enhancing interactivity as claimed in claim 2, wherein said first data unit is a cable modem.

5. The network infrastructure capable of enhancing interactivity as claimed in claim 2, wherein said first data unit is a wireless modem.

6. The network infrastructure capable of enhancing interactivity as claimed in claim 1, wherein said remote device further comprises a second data unit, which is coupled to said second micro-processing unit and said wide area network for data transmission between said near-end device and said wide area network.

7. The network infrastructure capable of enhancing interactivity as claimed in claim 6, wherein said second data unit is an ADSL modem.

8. The network infrastructure capable of enhancing interactivity as claimed in claim 6, wherein said second data unit is a cable modem.

9. The network infrastructure capable of enhancing interactivity as claimed in claim 6, wherein said second data unit is a wireless modem.

10. The network infrastructure capable of enhancing interactivity as claimed in claim 1, wherein said automatic login procedure comprises the steps of:
said first micro-processing unit's initialization of said remote device; and
logging in said service server via at least one account information of said first memory unit.

11. The network infrastructure capable of enhancing interactivity as claimed in claim 1, wherein said first memory unit saves at least an account information for logging in said service server.

12. The network infrastructure capable of enhancing interactivity as claimed in claim 11, wherein said account information is an E-mail address.

13. The network infrastructure capable of enhancing interactivity as claimed in claim 11, wherein said remote device is a network camera.

14. The network infrastructure capable of enhancing interactivity as claimed in claim 1, wherein said near-end is a personal computer.

15. The network infrastructure capable of enhancing interactivity as claimed in claim 1, wherein said near-end device is a mobile phone.

16. The network infrastructure capable of enhancing interactivity as claimed in claim 1, wherein said near-end device is a PDA.

17. The network infrastructure capable of enhancing interactivity as claimed in claim 1, wherein said response action returns an Internet Protocol Address of said remote device to said near-end device.

18. The network infrastructure capable of enhancing interactivity as claimed in claim 1, wherein said software is an instant messenger.

19. The network infrastructure capable of enhancing interactivity as claimed in claim 18, wherein said software is Yahoo Messenger.

20. The network infrastructure capable of enhancing interactivity as claimed in claim 18, wherein said software is Google Chat.

21. The network infrastructure capable of enhancing interactivity as claimed in claim 18, wherein said software is MSN Messenger.

22. The network infrastructure capable of enhancing interactivity as claimed in claim 18, wherein said software is Skype.

23. The network infrastructure capable of enhancing interactivity as claimed in claim 1, wherein said notification data are in the form of text.

24. The network infrastructure capable of enhancing interactivity as claimed in claim 1, wherein said notification data are in the form of video.

25. The network infrastructure capable of enhancing interactivity as claimed in claim 1, wherein said notification data are in the form of audio.

26. The network infrastructure capable of enhancing interactivity as claimed in claim 1, wherein said response action transmits at least a response data to said near-end device via said remote device.

27. The network infrastructure capable of enhancing interactivity as claimed in claim 26, wherein said response data is in the form of video.

28. The network infrastructure capable of enhancing interactivity as claimed in claim 26, wherein said response data is in the form of audio.

29. The network infrastructure capable of enhancing interactivity as claimed in claim 1, wherein said response action enables video connection between said remote device and said service server.

30. The network infrastructure capable of enhancing interactivity as claimed in claim 1, wherein said response action enables audio connection between said remote device and said service server.
